(19) United States
(12) Patent Application Publication
(10) Pub. No.: US 2011/0143148 A1
(43) Pub. Date: Jun. 16, 2011

(54) ARTICLES COMPRISING A WEATHER RESISTANT SILICONE COATING

(75) Inventors: Matthew David Butts, Rexford, NY (US); John Matthew Bablin, Malta, NY (US); David Gilles Gascoyne, Niskayuna, NY (US); Judith Stein, Schenectady, NY (US); William David Richards, Scotia, NY (US)

(73) Assignee: General Electric Company, Schenectady, NY (US)

(21) Appl. No.: 12/636,750

(22) Filed: Dec. 13, 2009

(51) Int. Cl. B32B 33/00; B32B 9/04; C08K 5/05; C08K 5/17; C08K 5/11; C08K 5/5419; C08K 5/13; C08L 83/04

(52) U.S. Cl. 428/447; 524/391; 524/186; 524/314; 524/268; 524/323; 524/588

(57) ABSTRACT

An article comprises a weatherable surface exposed to precipitation or airborne debris; and a weather resistant coating disposed on the weatherable surface, wherein the coating comprises component A, a one- or two-part room temperature vulcanizable polyorganosiloxane composition; and component B, an ice release-enhancing proportion of at least one polyorganosiloxane comprising one or more silanol or alkoxy-silyl groups and comprising from about 10 weight percent to about 85 weight percent of at least one hydroxy-terminated or alkoxy-terminated polyoxyalkylenealkyl radical; and any reaction products thereof. In another embodiment, an article comprises a weatherable surface exposed to precipitation or airborne debris; and a weather resistant coating disposed on the weatherable surface, wherein the coating includes a one- or two-part addition curable polyorganosiloxane composition comprising a resin polymer and a crosslinker, wherein the resin polymer and/or crosslinker comprises an ice release-enhancing proportion of covalently bound hydrophilic functionality that contributes from about 0.5 weight percent to about 40 weight percent of the coating composition; and any reaction products thereof.

### FIELD OF THE INVENTION

The invention includes embodiments that relate to coated articles. More particularly, the invention includes embodiments that relate to weather resistant coated articles.

### BACKGROUND OF THE INVENTION

The exposure of critical structures to harsh environments, including the effects of erosion and/or the accretion of ice or debris, poses many problems with respect to efficiency of operation and safety. For example, accretion of ice in aircraft engines is a significant problem in the aviation industry. Atmospheric icing can affect the performance of fan blades, inlet guide vanes, fan exit guide vanes, etc. and in extreme cases can result in engine flameouts. Ice accretion on aircraft fuselages and wings also poses a hazard, affecting aerodynamic performance and safety. The problems are not limited to the aviation industry. Ice buildup on wind turbine blades in cold climates can reduce the efficiency of power generation, sometimes requiring turbine shutdown.

Presently there exist a number of methods for actively ice-protecting critical structures operating in harsh environments. These include the spraying of hot de-icing fluids at high pressures (aircraft wings) or the routing of hot air or resistive heating (aircraft engines). Mechanical systems, on the other hand, physically remove accreted ice by deforming the underlying structure through the use of surface actuation, such as in small aircraft propeller blades. Specialized icephobic coatings are an attractive alternative. A coatings approach presents a passive method for controlling ice accretion that may be integrated into existing structures and designs. Unlike de-icing fluids, these coatings are long lasting and are not environmentally hazardous. Furthermore, coatings do not increase the energy cost of the system, unlike wing/blade heating or pneumatic covering approaches. Despite over half a century's worth of targeted research and development, no existing coating technology has been both successfully commercialized and satisfactorily proven effective in the field.

In addition to the problem of ice accretion, structures exposed to the environment are often subjected to other detrimental effects of weathering, such as erosion by particles or rain, for example, or the accumulation of debris, such as dirt or insects over time. Thus, there is a need for durable, weather resistant coatings that can be applied to parts that are exposed to environmental weathering.

### BRIEF SUMMARY OF THE INVENTION

The coatings of the present invention have been found to substantially reduce the adhesion strength of ice to the surface of coated parts. Furthermore, the coatings exhibit significant resistance to other harsh environmental factors including sand or grit erosion as well as the buildup of debris such as dirt or insects.

In one embodiment, an article comprises a weatherable surface exposed to precipitation or airborne debris; and a weather resistant coating disposed on the weatherable surface, wherein the coating comprises component A, a one- or two-part room temperature vulcanizable polyorganosiloxane composition; and component B, an ice release-enhancing proportion of at least one silicon-containing compound comprising one or more silanol or alkoxy-silyl groups and comprising from about 10 weight percent to about 85 weight percent of at least one hydroxy-terminated or alkoxy-terminated polyoxyalkylenealkyl radical; and any reaction products thereof.

In another embodiment, an article comprises a weatherable surface exposed to precipitation or airborne debris; and a weather resistant coating disposed on the weatherable surface, wherein the coating includes a one- or two-part addition curable polyorganosiloxane composition comprising a resin polymer and a crosslinker, wherein the resin polymer and/or crosslinker comprises an ice release-enhancing proportion of covalently bound hydrophilic functionality that contributes from about 0.5 weight percent to about 40 weight percent of the coating composition; and any reaction products thereof.

### BRIEF DESCRIPTION OF THE DRAWINGS

FIG. 1 displays ice adhesion data for coating compositions comprising AK21XS and AK3067 with and without the addition of 5 weight percent additive 1.

FIG. 2 displays ice adhesion data for coating compositions comprising AK21XS and AK21XS with varying percentages of additive 2.

FIG. 3 illustrates ice adhesion data for a single coupon of AK3067 comprising 5 weight percent of additive 1.

FIG. 4 displays grit erosion data for coating compositions comprising AK3067 with and without 5 weight percent additive 1.

FIG. 5 displays grit erosion data for coating compositions comprising AK21XS with and without 10 weight percent additive 2.

### DETAILED DESCRIPTION OF THE INVENTION

Disclosed herein are coating compositions with improved icephobic, erosion resistance and debris resistance properties. The combination of specifically defined silicone additives and curable silicone materials provides coating compositions that reduce the strength of ice adhesion on article surfaces. In some embodiments, the coating compositions are particularly useful in protecting one or more weatherable surfaces, including the surfaces of parts which are exposed to environmental weathering from degradation by the surrounding environment or the buildup of ice or debris such as dirt or insects. As used herein, the term “weather resistant” refers to the resistance to buildup of debris such as dirt or insects, the resistance to erosion (for example by dirt or rain), and the resistance to ice adhesion. The term “erosion resistant” refers to resistance to erosion induced by impacting solid or liquid particles and/or impingement. The weather resistant coatings are also resistant to degradation by environmental factors including extreme temperature, and sunlight.

The term “icephobic” is used to describe a coating that reduces the adhesion strength of ice to a surface, e.g. reduces the shear force required to remove the ice. In certain embodiments, the weatherable surface is an aerodynamic surface, including, but not limited to, the surface of aircraft components or wind turbine components. The weatherable surface can include the surface of structures, equipment and components or parts of equipment that encounter the environment, including moisture in air. Examples of components that can be protected by the disclosed coatings include, but are not limited to, aircraft engine components such as fan blades and air splitters as well as aircraft fuselages, aircraft wings, aircraft propeller blades, wind turbine blades, gas turbines and off-shore oil and gas structures.

In some embodiments, it is desirable to prevent the loss of material from, or alteration of the dimensions of, a component or part through either erosion or the buildup of ice or debris thereon, so that the original shape, volume, contours and aerodynamic properties of the part are most nearly preserved. The coating compositions disclosed herein protect the weatherable structure from erosion caused by particle impact and/or impingement. Erosion by particle impact is caused by particles carried in air currents. Erosion by impingement includes degradation caused by liquid droplets carried by air currents which can additionally lead to corrosion. More than one of the mechanisms of particle impact or impingement, can simultaneously act on a weatherable structure.

The word “component” is frequently employed herein to refer to a structural part, or alternatively, to designate the materials present in the compositions of the invention. Component A of the coating compositions of the invention can be a conventional one-part or two-part room temperature vulcanizable (hereinafter sometimes “RTV”) composition. These are often also referred to as “moisture cure” compositions. It typically comprises at least one reactive polyorganosiloxane (hereinafter sometimes designated “silicone” for brevity), at least one condensation catalyst and at least one crosslinking agent.

The reactive silicone is most often a polydialkylsiloxane, typically of the formula:

R¹(SiR²R²O)ₘSiR²R²R¹ (I)

wherein each R¹ is hydroxyl or

—O—Si(R³)ₐ—(OR⁴)₃₋ₐ (II)

and wherein each R² is independently a hydrocarbon or fluorinated hydrocarbon radical, each R³ and R⁴ is a hydrocarbon radical, a is 0, 1 or 2 and m has a value such that the viscosity of said reactive silicone under ambient temperature and pressure conditions is up to about 160,000 centipoise. Illustrative hydrocarbon radicals are C₁₋₂₀ alkyl, C₆₋₂₀ aryl, alkylaryl, vinyl, isopropenyl, allyl, butenyl, methyl and hexenyl. An illustrative fluorinated hydrocarbon radical is 3,3,3-trifluoropropyl. Most often each R², R³ and R⁴ is alkyl or methyl. R¹, R², R³ and R⁴ are not hydrophilic. In one embodiment, the reactive silicone is present in the component A composition at a concentration from about 40 weight percent to about 98 weight percent. In another embodiment, the reactive silicone is present in the component A composition at a concentration from about 60 weight percent to about 98 weight percent.

It is within the scope of the invention to employ two or more reactive silicones, differing in average molecular weight. This may afford a bimodal composition having performance advantages over a simple monomodal composition.

The condensation catalyst may be any of those known to be useful for promoting condensation curing of an RTV material. Suitable catalysts include compounds of tin, zirconium, titanium and aluminum, as illustrated by dibutyltindilaurate, dibutyltindiacetate, dibutyltin methoxide, dibutyltin bis (acetylacetonate), diisopropoxidetitanium bis(acetylacetonate), titanium naphthenate, tetrabutyltitanate, and zirconium octanoate or mixtures thereof. Various salts of organic acids or mixtures of salts with such metals as lead, iron, cobalt, manganese, zinc, antimony and bismuth may also be employed, as may non-metallic catalysts such as hexylammonium acetate and benzyltrimethylammonium acetate. In one embodiment, the condensation catalyst is present in the component A composition at a concentration from about 0.01 weight percent to about 10 weight percent. In another embodiment, the condensation catalyst is present in the component A composition at a concentration from about 0.05 weight percent to about 4.0 weight percent.

As crosslinking agents, trifunctional (T) and tetrafunctional (O) silanes are useful, the term “functional” in this context denoting the presence of a silicon-oxygen bond. They include compounds such as methyltrimethoxysilane, methyltriethoxysilane, 2-cyanoethyltrimethoxysilane, methyl triacetoxysilane, tetraethyl silicate, and tetra-n-propyl silicate. Other crosslinking agents could be ketoximinosilanes, enoxysilanes, or alkenylsilanes such as vinyl tris (methylethylketoximino)silane or vinyl triacetoxysilane. Mixtures of crosslinking agents may also be used. In one embodiment, the crosslinking agent is present in the component A composition at a concentration from about 0.10 weight percent to about 20 weight percent. In another embodiment, the crosslinking agent is present in the Component A composition at a concentration from about 1.0 weight percent to about 10 weight percent.

Component B is a silicon-containing compound comprising one or more silanol or alkoxysilyl groups and at least one hydrophilic group. The hydrophilic group may be a hydroxy- or alkoxy-terminated polyoxyalkylenealkyl radical. Said radical or radicals comprise from about 10 weight percent to about 85 weight percent of component B; that is, the molecular weight attributable to said radicals is about 10 to about 85 percent of the total molecular weight attributable to component B. In one embodiment, component B represents from about 0.1 weight percent to about 50 weight percent of the coating composition. In another embodiment, component B represents from about 0.2 weight percent to about 30 weight percent of the coating composition. Without intending to be limited by theory, suitable component B compounds are those which are theoretically capable of covalently bonding to one or more constituents of component A upon curing of the coating composition.

In some embodiments, component B comprises compounds of the formula

R⁵(SiR⁶R⁷O)ₙSiR⁶R⁷R⁵ (III)

wherein R⁵, R⁶ and R⁷ are independently defined as follows: at least one of the R^{5,6,7} radicals has the formula

—R⁸—(OR⁹)_{z}—OR¹⁰; (IV)

at least one of the R^{5,6,7} radicals is a hydroxyl group or an OR¹¹ group; and any remaining R^{5,6,7} radicals are hydrocarbon or fluorinated hydrocarbon radicals, wherein R⁸ and each R⁹ are independently a C₂₋₆ alkylene or a substituted alkylene, R¹⁰ is hydrogen or a C₁₋₄ primary or secondary alkyl, and R¹¹ is a C₁₋₁₀ primary or secondary alkyl; n has a value such that the weight average molecular weight of the compound is in the range of about 300 to about 40,000; and z and the number of radicals of formula (IV) are defined such component B comprises from about 10 weight percent to about 85 weight percent radicals of formula (IV). The illustrative radicals for R⁵⁻⁷ are the same as for R², provided that at least one of these radicals has the formula (IV) and at least one of these radicals is a hydroxyl or OR¹¹ group. R⁸ and R⁹ may be, for example, ethylene, propylene, or trimethylene. R¹⁰ is most often hydrogen or methyl.

Illustrative examples of compounds of formula (III) are (MeO)₃Si(CH₂)₃(OCH₂CH₂)₃OMe, (MeO)₃Si(CH₂)₃(OCH₂CH₂)₆₋₉OMe and (MeO)₃Si(CH₂)₃(OCH₂CH₂)₉₋₁₂OMe, which are all available from Gelest, Inc., as well as copolymers such as (EtO)₃SiO(SiMe₂O)₂₀(SiMe(CH₂CH₂CH₂(OCH₂CH₂)₁₂OH)O)₅Si(OEt)₃ and Me₂(EtO)SiO(SiMe₂O)₂₀(SiMe(CH₂CH₂CH₂(OCH₂CH₂)₁₂OH)O)₅Si(OEt)Me₂, with the number of repeat units being averages. Polymers of this type can be random copolymers or block copolymers.

In other embodiments, component B comprises compounds of the formula

R¹²R¹³R¹⁴Si(OSiR²₂)ₓ—R⁸—(OR⁹)_{z}O—R⁸(R²₂SiO)_{y}SiR¹²R¹³R¹⁴ (V)

wherein at least one of the independent R¹², R¹³ and R¹⁴ groups is a hydroxyl group or an OR¹¹ group and any remaining R¹², R¹³ and R¹⁴ groups are independently hydrocarbon radicals, fluorinated hydrocarbons or radicals of formula (IV); R², R⁸ and R⁹ radicals are as defined above; and x, y and z have values such that the average molecular weight of the compound is in the range of about 400 to about 50,000 and the compound comprises at least about 5% by weight non silicone material. The illustrative hydrocarbon or fluorinated hydrocarbon radicals for R¹²⁻¹⁴ are the same as for R².

One illustrative compound of formula (V) is bis(triethoxysilylpropyl)polyethylene oxide (25-30 ethylene oxide units) which is available from Gelest, Inc., with the catalog number SIB1824.84. More generally, the compounds employed as component B should contain radicals of formula (IV) in an amount to provide about from about 5 percent to about 80 percent by weight of the molecule.

In another embodiment, the coating composition comprises a one- or two-part addition curable polyorganosiloxane composition comprising a resin polymer and a crosslinker, wherein the resin polymer and/or the crosslinker comprises an ice release-enhancing proportion of covalently bound hydrophilic functionality that contributes from about 0.5 weight percent to about 40 weight percent of the total composition; and any reaction products thereof. In some embodiments, the hydrophilic functionality comprises polyoxyalkylene radicals.

The addition curable coating compositions of the present invention comprise an alkenyl-containing polyorganosiloxane (the resin polymer), a hydride-containing polyorganosiloxane (the crosslinker), a catalytic amount of a hydrosilation catalyst and optionally an inhibitor, provided that either the alkenyl-containing polyorganosiloxane or the hydride-containing polyorganosiloxane further comprises at least one polyoxyalkylenealkyl radical of formula (IV). In some embodiments, both the alkenyl-containing polyorganosiloxane and the hydride-containing polyorganosiloxane comprise at least one polyoxyalkylenealkyl radical. The alkenyl-containing polyorganosiloxane has the general formula:

(R¹²)₂R¹³SiO[(R¹²)₂SiO]ᵣ[R¹²R¹³SiO]ₛSi(R¹²)₂R¹³ (VI)

wherein at least two R¹³ groups are ethylenic unsaturated radicals, for example vinyl, wherein the remaining R¹³ and R¹² groups are selected from the group consisting of C₁₋₈ alkyl radicals, phenyl radicals and C₃₋₁₀ fluoroalkyl radicals and mixtures thereof, r+s has a value sufficient to provide a total vinyl-containing composition with a viscosity in the range between about 50 centipoise and about 500,000 centipoise at 25 degrees Celsius and a vinyl content in a range between about 0.01 weight percent and about 5.0 weight percent of the alkenyl-containing polyorganosiloxane. In one embodiment, radicals represented by R¹² are C₁₋₄ alkyl radicals, including for example, methyl. Typically the alkenyl-containing polymer is present in a range between about 10 weight percent and about 95 weight percent of the total addition curable composition.

The alkenyl-containing polyorganosiloxane may also include a vinyl-containing siloxane resin copolymer which may be present in a range between zero weight percent and about 70 weight percent of the total alkenyl-containing polyorganosiloxane. The vinyl-containing siloxane resin copolymer may have the formula:

[(R¹⁴)₃SiO_{1/2}]—[SiO_{4/2}] (“M” and “Q” units, respectively)

wherein each R¹⁴ is independently either a vinyl radical or a monovalent hydrocarbon radical free of aliphatic unsaturation and containing no more than six carbon atoms, the ratio of (R¹⁴)₃SiO_{1/2} M units to SiO_{4/2} Q units being in the range of about 0.5:1 and about 1.5:1, and the resin having a vinyl content in a range between about 1.5 weight percent and about 3.5 weight percent of the vinyl containing siloxane resin copolymer. The vinyl containing siloxane resin copolymer is also referred to as a vinyl containing MQ resin or M^{vi}Q.

The vinyl containing siloxane resin copolymer may further contain R¹⁴SiO_{3/2} units (T), (R¹⁴)₂SiO_{2/2} (D), or combinations thereof, where the R¹⁴SiO_{3/2} and (R¹⁴)₂SiO_{2/2} units are present in an amount in the range between about 0 mole percent and about 10 mole percent based on the total number of moles of siloxane units in the vinyl containing siloxane resin copolymer. R¹⁴ is defined as above.

The hydride-containing polysiloxane, which is free of aliphatic unsaturation, functions as a crosslinker and is typically present in a range between about 0.5 weight percent and about 50 weight percent based on the total weight of the addition curable composition.

In one embodiment, a hydride-containing polysiloxane has the formula

(R¹⁵)₃SiO—[(R¹⁵)(H)SiO]ᵥ—[(R¹⁵)₂SiO]_{w}—Si(R¹⁵)₃ (VII)

where R¹⁵ is independently hydrogen, a monovalent hydrocarbon radical, or a halogenated monovalent hydrocarbon radical having carbon atoms in the range between about 1 and about 10; v and w have values which are sufficient when added together to provide a viscosity of the hydride-containing polysiloxane in a range between about 10 centipoise and about 50,000 centipoise at 25 degrees Celsius; and the active hydrogen content is in a range between about 0.001% and about 3% by weight of the hydrogen containing polysiloxane. R¹⁵ may be selected from C₁₋₈ alkyl radicals, phenyl, C₃₋₁₀ fluoroalkyl radicals and hydrogen. The hydride-containing polysiloxane comprises at least three Si—H groups. An example of a suitable fluoroalkyl radical is trifluoropropyl. The hydrogen containing polysiloxane of formula (VII) can be used as a hydride crosslinking agent in the present formulation.

The alkenyl-containing polyorganosiloxane formula (VI) and the hydrogen containing polysiloxane formula (VII) can each comprise a radical having formula (IV) that is chemically bonded to each structure.

The coating composition also contains a hydrosilation catalyst that promotes the hydrosilation curing reaction. The hydrosilation catalyst is typically a platinum group metal, metal compound or mixtures thereof. Other catalysts include precious metals such as ruthenium, rhodium, osmium, or iridium, complexes of these metals or mixtures thereof. The hydrosilation catalyst may be a platinum containing inorganic or organometallic compound. The platinum-containing catalyst may be a platinum complex formed by allowing chloroplatinic acid containing about 4 moles of water of hydration to react with divinyltetramethyldisiloxane. This catalyst is disclosed in U.S. Pat. No. 3,775,452 and is often referred to as Karstedt's catalyst.

In one embodiment, the addition curable composition includes an inhibitor or mixture of inhibitors. Inhibitors such as acetylenic alcohols, amines, di-alkenyl maleates and di-alkenyl fumarates, tetravinyltetramethylcyclotetrasiloxane and mixtures thereof can be used in an effective amount which is typically in a range between about 0.01 weight percent and about 1 weight percent of the total composition.

The component A or addition curable compositions described herein may contain other constituents such as reinforcing and extending (non-reinforcing) fillers. An example of a commercially available reinforcing filler is Aerosil® manufactured by Evonik Industries. Suitable reinforcing fillers have a primary particle size of about 5 nm to about 20 nm, and are available in the form of aggregated particles having an average size from about 50 nm to about 300 nm. Suitable fillers include silica fillers, including fumed silica and precipitated silica. Theses two forms of silica have surface areas in the ranges of 90 to 325 m²/g and 8 to 150 m²/g, respectively. Colloidal silica may also be used.

The reinforcing filler is most often pretreated with a treating agent to render it hydrophobic. Typical treating agents include cyclic siloxanes, such as cyclooctamethyltetrasiloxane, and acyclic and cyclic organosilazanes such as hexamethyldisilazane, 1,3 divinyl-1,1,3,3,-tretramethyldisilazane, hexamethylcyclotrisilazane, octamethylcyclotetrasilazane and mixtures of these.

Non-reinforcing fillers include titanium dioxide, lithopone, zinc oxide, zirconium silicate, iron oxides, diatomaceous earth, calcium carbonate, mica, aluminum oxides, glass fibers or spheres, magnesium oxide, chromic oxide, zirconium oxide, crushed quartz, calcined clay, talc, kaolin, asbestos, carbon, graphite, cork, cotton, synthetic fibers, and carbon nanotubes. More than one type of filler may be included in the composition, for example both silica and glass may be added to a composition.

The coating compositions of this invention may also incorporate further constituents such as non-reactive silicone oils, dyes, pigments, solubilizing agents and solvents to render them sprayable if sprayability is desired. These may be introduced as part of component A, as one or more components of the addition curable composition, or as adjuvants to the entire composition, as appropriate. Suitable solvents include aromatic hydrocarbons such as toluene or xylene and aliphatic hydrocarbons such as petroleum naphtha.

In certain embodiments, the coating compositions disclosed herein include an antioxidant. The antioxidant can be present in the coating composition in an amount between about 0.01 weight percent and about 5 weight percent based on the total weight of the coating composition. In one embodiment, the antioxidant is present in the coating composition in an amount between about 0.01 weight percent and about 2 weight percent based on the total weight of the coating composition. An example of a suitable antioxidant is 2,2′-methylene-bis(4-methyl-6-tert-butylphenol).

Coatings comprising compositions of the present invention can be applied directly to a structure, part, piece of equipment or one or more components of equipment, or may be applied to one or more other coatings that exist on the structure, etc. The coatings can be applied by any method known to those skilled in the art, such as by spraying, roll coating, brush painting, doctor blading or dip or flow coating. The coating thickness after drying is from about 1 mil to about 200 mils.

In some embodiments, the moisture cure coating compositions of the present invention are applied in two or more steps. First, only component A is applied to a substrate or primed substrate, and then after a suitable amount of time, a second coat (and optionally subsequent coats) comprising both component A and component B is applied. Similarly, addition curable coatings can be prepared in two or more steps in some embodiments. First, a one or two part addition curable composition devoid of any hydrophilic functionality is applied, followed by one or more coats of addition curable compositions comprising covalently bound hydrophilic functionality.

The following examples are intended only to illustrate methods and embodiments in accordance with the invention and as such should not be construed as imposing limitations upon the claims. All AEROKRET silicone formulations were obtained from Analytical Services & Materials, Inc. (AS&M). Note that in some instances, examples including formulations of AEROKRET 3067 utilized exact replicas of the AEROKRET 3067 formulation. All coatings of the invention also comprised 1.25 weight percent (relative to the weight of additive) 2,2′-methylene-bis(4-methyl-6-tert-butylphenol).

### EXAMPLES

### Example 1

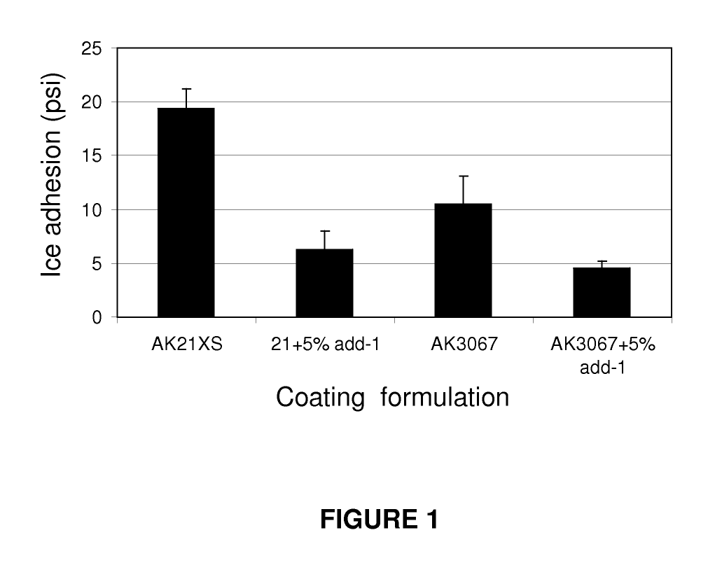

The moisture cure silicone coating formulation AEROKRET 21XS (AK21XS) was applied in two coats to a primed aluminum substrate and allowed to cure to produce a first coated substrate. Separately, a second coated substrate was produced by first applying a single coat of AK21XS to a primed aluminum substrate. After two hours, a single coating of AK21XS, comprising 5 weight percent (based on the total weight of the final cured coating) the reactive additive (MeO)₃Si(CH₂)₃(OCH₂CH₂)₁₄OH (additive 1), was applied to the first coat of AK21XS and allowed to cure. Third and fourth coated substrates were produced by repeating these two experiments with the replacement of AK21XS with AK3067. The adhesion strength of rime ice to the coated substrates was measured in an icing wind tunnel using a proprietary fixture. The ice adhesion data, measured in psi (pounds per square inch), is shown in FIG. 1. It is clear from this data that the coatings disclosed herein exhibit significantly reduced ice adhesion strength.

### Example 2

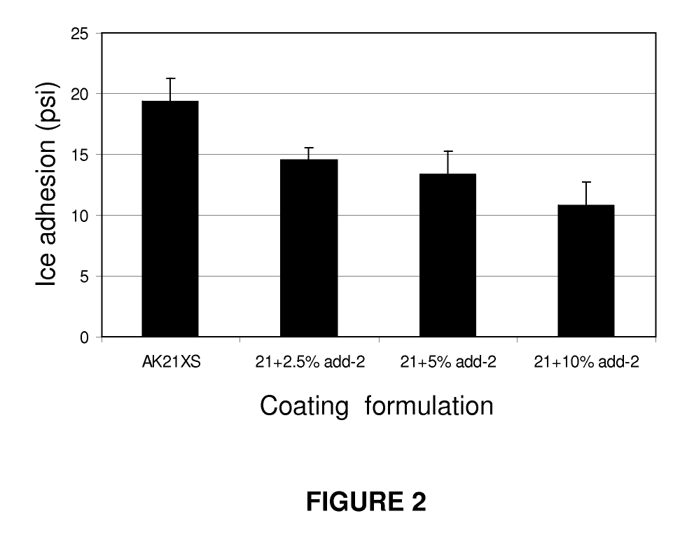

Two coats of AK21XS were applied to a primed aluminum substrate. Separately, additional primed substrates were coated with a single coat of AK21XS. After two hours, the single coated substrates were further coated with AK21XS comprising the additive bis(triethoxysilylpropyl)polyethylene oxide (25-30 ethylene oxide units, Gelest, Inc., additive 2) in increasing concentration. These separate coatings comprised 2.5, 5 and 10 weight percent of additive 2 with respect to the final cured coating. The adhesion strength of rime ice to each coated substrate was measured in an icing wind tunnel using a proprietary fixture. As displayed in FIG. 2, the coatings comprising additive 2 exhibited significantly reduced ice adhesion strength relative to AK21XS. The high reproducibility of these results is evidenced by the data shown in FIG. 2 for the coating comprising 10 weight percent additive 2, representing a total of 18 cycles of icing measurements performed on multiple coupons prepared from coatings made on three different days.

### Example 3

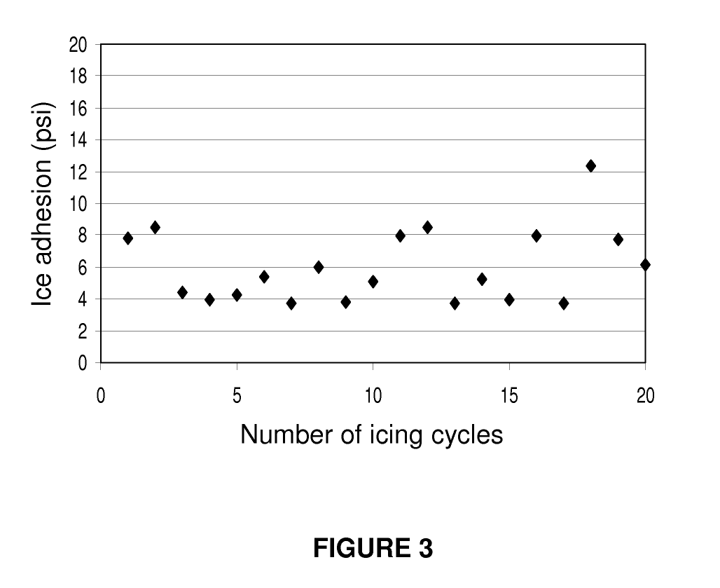

The adhesion strength of rime ice was measured, in an icing wind tunnel using a proprietary fixture, on a single coupon coated with AK3067 mixed with 5 weight percent of additive 1 (based on the total weight of the final cured coating) for a total of 20 icing cycles. As illustrated in FIG. 3, the ice release performance of the coating was durable through multiple icing cycles.

### Example 4

The adhesion of rime ice to replicates of two different coatings was measured in an icing wind tunnel using a proprietary fixture, before and after heat aging at 60 degrees Celsius for 7 days. The first coating comprised AK21XS and 5 weight percent of additive 1. The second coating comprised AK21XS and 10 weight percent additive 2. The data shown in Table 1 below clearly indicates that heat aging did not adversely affect the ice release properties of either coating.

TABLE 1

| | Ice adhesion before | Ice adhesion after heating |
|---|---|---|
| Coating | heat aging (psi) | to 60° C. for 7 days (psi) |
| 21XS + 5% additive 1 | 6.30 ± 1.66 | 6.44 ± 1.05 |
| 21XS + 10% additive 2 | 11.76 ± 1.37 | 10.11 ± 1.90 |

### Example 5

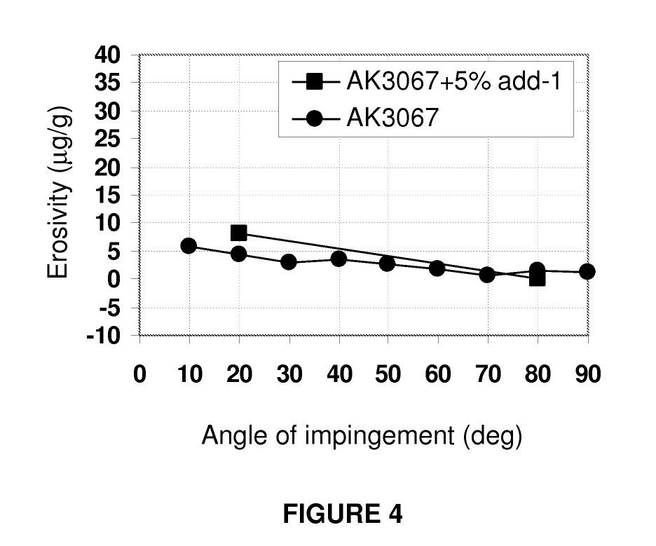

A coat of AK3067 was applied to a primed aluminum substrate. Similarly, a coat of AK3067 with 5 weight percent additive 1 was applied a primed aluminum substrate. The grit erosion resistance of each of the coatings was determined by measuring the weight loss following particle impact as a function of the angle of impingement. Each coupon was eroded with 300 grams of #120 white aluminum oxide. The data reported in FIG. 4 indicates that the erosion resistance of AK3067 coatings is not compromised when additive 1 is added to the coating composition.

### Example 6

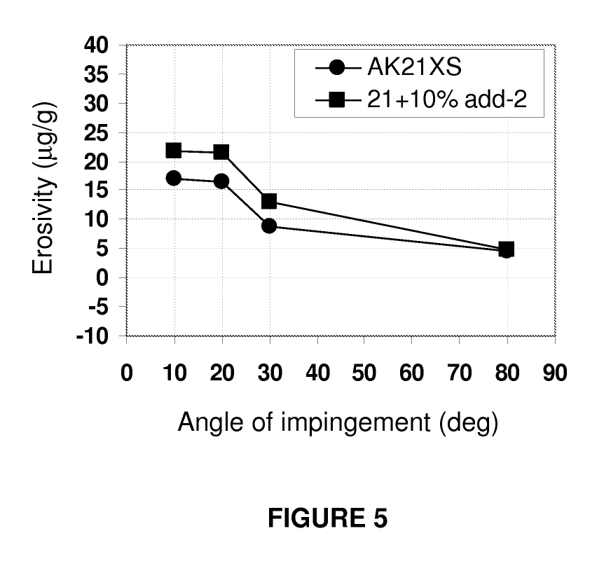

AK21XS coatings, with and without 10 weight percent additive 2, were applied to separate primed aluminum substrates. The grit erosion resistance of the coated substrates was determined by measuring the weight loss following particle impact as a function of the angle of impingement. Each coupon was eroded with 300 grams of #120 white aluminum oxide. The data reported in FIG. 5 indicates that the erosion resistance of AK21XS coatings is not significantly compromised when additive 2 is added to the coating composition.

### Example 7

An addition curable composition comprising covalently bound polyoxyalkylenealkyl radicals was synthesized and used to prepare coatings. The silicone polymer Me₃Si(OSiHMeO)₁₅(OSiMe₂)₁₈₅OSiMe₃ (15.0 g, 0.001015 moles), polyglycol AM350 (2.49 g, 0.0071 moles, Clariant, CH₂CHCH₂(OCH₂CH₂)₆Me), 5 weight percent platinum on aluminum (1.2 g), and isopropanol (121 mL) were combined in a 250 mL round bottom flask. The solution was stirred with a magnetic stir bar and heated to 70 degrees Celsius for 18 hours. The reaction mixture was cooled to room temperature. The platinum on aluminum was removed by filtration through a 0.45 micron filter. Hexamethyldisilazane-treated silica gel (2.2 g, Gelest Inc.) was mixed into the solution and the volatiles were removed under reduced pressure. The resulting oil was mixed with the silicone polymer (vinyl)Me₂Si(OSiMe₂)₂₀OSiMe₂(vinyl) (6.78 g, 0.00406 moles), 2,2′-methylenebis(6-tertbutyl-4-methylphenol) (0.0311 g) and platinum catalyst 89023 (0.019 g, Momentive Performance Materials). A coating was applied onto a primed metal substrate and was cured at 60 degrees Celsius for 4 hours. This coating is referred to in Example 9 as “pegylated-addcure”.

### Example 8

An addition curable composition which did not comprise polyoxyalkylenealkyl radicals was synthesized as a control sample to the composition of Example 7, and was used to prepare coatings. The silicone polymer Me₃Si(OSiHMeO)₁₅(OSiMe₂)₁₈₅OSiMe₃ (15.0 g, 0.001015 moles), vinyltrimethyl silane (0.71 g, 0.0071 moles), 5 weight percent platinum on aluminum (1.2 g), and isopropanol (121 mL) were mixed in a 250 mL round bottom flask. The solution was stirred with a magnetic stir bar and heated to 70 degrees Celsius for 18 hours. The reaction mixture was then cooled to room temperature. The platinum on aluminum was removed by filtration through a 0.45 micron filter. Hexamethyldisilazane-treated silica gel (2.2 g, Gelest Inc.) was mixed into the solution and the volatiles were removed under vacuum. The resulting oil was mixed with the silicone polymer (vinyl)Me₂Si(OSiMe₂)₂₀OSiMe₂(vinyl) (6.78 g, 0.00406 moles) and platinum catalyst 89023 (0.019 g, Momentive Performance Materials). A coating was applied onto a primed metal substrate and was cured at 60 degrees Celsius for 4 hours. This coating is referred to in Example 9 as “non-pegylated-addcure”.

### Example 9

The adhesion strength of rime ice was measured, in an icing wind tunnel using a proprietary fixture, on the coating of Example 7 and the control coating of Example 8. The ice adhesion strength was found to be 6.46±0.96 psi on the pegylated-addcure coating and 9.64±1.98 psi on the non-pegylated-addcure coating. Thus, it is evident that the addition curable coating composition of the present invention exhibited reduced ice adhesion when compared to a control addition curable coating that did not contain polyoxyalkylenealkyl radicals.

All ranges disclosed herein are inclusive of the endpoints, and the endpoints are combinable with each other. The terms “first,” “second,” and the like as used herein do not denote any order, quantity, or importance, but are used to distinguish one element from another. The modifiers “about” and “approximately” used in connection with a quantity are inclusive of the stated value and have the meaning dictated by the context (e.g., includes the degree of error associated with measurement of the particular quantity). The use of the terms “a” and “an” and “the” and similar referents in the context of describing the invention (especially in the context of the following claims) are to be construed to cover both the singular and the plural, unless otherwise indicated herein or clearly contradicted by context.

While the invention has been described in detail in connection with a number of embodiments, the invention is not limited to such disclosed embodiments. Rather, the invention can be modified to incorporate any number of variations, alterations, substitutions or equivalent arrangements not heretofore described, but which are commensurate with the spirit and scope of the invention. Additionally, while various embodiments of the invention have been described, it is to be understood that aspects of the invention may include only some of the described embodiments. Accordingly, the invention is not to be seen as limited by the foregoing description, but is only limited by the scope of the appended claims.

What is claimed is:

1. An article comprising:
a weatherable surface exposed to precipitation or airborne debris; and
a weather resistant coating disposed on the weatherable surface, wherein the coating comprises:
component A, a one- or two-part room temperature vulcanizable polyorganosiloxane composition; and
component B, an ice release-enhancing proportion of at least one polyorganosiloxane comprising one or more silanol or alkoxy-silyl groups and comprising from about 10 weight percent to about 85 weight percent of at least one hydroxy-terminated or alkoxy-terminated polyoxyalkylenealkyl radical;
and any reaction products thereof.

2. The article of claim 1, wherein component A comprises at least one reactive silicone, at least one condensation catalyst, and at least one crosslinking agent.

3. The article of claim 2, wherein the reactive silicone comprises a polydialkylsiloxane having the formula
R¹(SiR²R²O)ₘSiR²R²R¹ (I)
wherein each R¹ is hydroxyl or
—O—Si(R³)ₐ—(OR⁴)₃₋ₐ (II)
and wherein each R² is independently a hydrocarbon or fluorinated hydrocarbon radical, each R³ and R⁴ is a hydrocarbon radical, a is 0, 1 or 2 and m has a valued such that the viscosity of said reactive silicone under ambient temperature and pressure conditions is up to about 160,000 centipoise.

4. The article of claim 3, wherein each R², R³ and R⁴ is methyl.

5. The article of claim 2, wherein the condensation catalyst comprises a compound of tin, zirconium, titanium or aluminum.

6. The article of claim 2, wherein the crosslinking agent is a trifunctional or tetrafunctional silane.

7. The article of claim 1, wherein component B comprises compounds having the formula
R⁵(SiR⁶R⁷O)ₙSiR⁶R⁷R⁵ (III)
wherein at least one of the R^{5,6,7} radicals has the formula
—R⁸—(OR⁹)_{z}—OR¹⁰; (IV)
wherein at least one of the R^{5,6,7} radicals is a hydroxyl group or an OR¹¹ group and any remaining R^{5,6,7} radicals are hydrocarbon or fluorinated hydrocarbon radicals; R⁸ and each R⁹ are a C₂₋₆ alkylene or a substituted alkylene; R¹⁰ is hydrogen or a C₁₋₄ primary or secondary alkyl, and R¹¹ is a C₁₋₁₀ primary or secondary alkyl; n has a value such that the weight average molecular weight of the compound is in a range of about 300 to about 40,000; and z and the number of radicals of formula (IV) are defined such that component B comprises from about 10 weight percent to about 85 weight percent radicals of formula (IV).

8. The article of claim 7, wherein R⁸ and R⁹ are ethylene, propylene, or trimethylene.

9. The article of claim 7, wherein R¹⁰ is hydrogen or methyl.

10. The article of claim 1, wherein component B comprises compounds of the formula
R¹²R¹³R¹⁴Si(OSiR²₂)ₓ—R⁸—(OR⁹)_{z}O—R⁸(R²₂SiO)_{y}SiR¹²R¹³R¹⁴ (V)
wherein at least one of the R¹², R¹³ and R¹⁴ groups is a hydroxyl group or an OR¹¹ group and any remaining R¹², R¹³ and R¹⁴ groups are a hydrocarbon radical, a fluorinated hydrocarbon or a radicals of formula IV; wherein each R² a hydrocarbon or fluorinated hydrocarbon radical, wherein R⁸ and R⁹ are independently a C₂₋₆ alkylene or a substituted alkylene; and x, y and z have values such that the average molecular weight of the compound is in the range of about 400 to about 50,000 and the compound comprises at least about 5% by weight of non silicone material.

11. The article of claim 1, wherein component B is present in the coating composition in an amount of about 0.1 weight percent to about 50 weight percent.

12. The article of claim 1, further comprising a reinforcing or non-reinforcing filler.

13. The article of claim 1, further comprising an antioxidant.

14. The article of claim 13, wherein the antioxidant is present in an amount between about 0.01 weight percent and about 5 weight percent based on the total weight of the coating composition.

15. The article of claim 13, wherein the antioxidant comprises 2,2′-methylene-bis(4-methyl-6-tert-butylphenol).

16. The article of claim 1, wherein the weatherable surface is an aerodynamic surface.

17. The article of claim 1, wherein the article is an aircraft component.

18. The article of claim 1, wherein the article is a wind turbine component.

19. The article of claim 1, further comprising:
a second coating disposed between the weatherable surface and the weather resistant coating, wherein the second coating comprises component A and not component B.

20. An article comprising:
a weatherable surface exposed to precipitation or airborne debris; and
a weather resistant coating disposed on the weatherable surface, wherein the coating comprises:
a one- or two-part addition curable polyorganosiloxane composition including a resin polymer and a crosslinker, wherein the resin polymer and/or the crosslinker comprises an ice release-enhancing proportion of covalently bound hydrophilic functionality that contributes from about 0.5 weight percent to about 40 weight percent of the coating composition;
and any reaction products thereof.

21. The article of claim 20, wherein the hydrophilic functionality comprises a polyoxyalkylenealkyl radical.

22. The article of claim 20, wherein the addition curable composition comprises an alkenyl-containing polyorganosiloxane, a hydride-containing polyorganosiloxane, a hydrosilation catalyst, and an inhibitor.

23. The article of claim 22, wherein the alkenyl-containing polyorganosiloxane has the formula
(R¹²)₂R¹³SiO[R¹²)₂SiO]ᵣ[R¹²R¹³SiO]ₛSi(R¹²)₂R¹³ (VI)
wherein at least two R¹³ groups are an ethylenic unsaturated radical, wherein the remaining R¹³ and R¹² are selected from the group consisting of C₁₋₈ alkyl radicals, phenyl radicals and C₃₋₁₀ fluoroalkyl radicals and mixtures thereof, r+s has a value sufficient to provide a total vinyl-containing composition with a viscosity in the range between about 50 centipoise and about 100,000 centipoise at 25 degrees Celsius and a vinyl content in a range between about 0.01 weight percent and about 4.0 weight percent of the alkenyl-containing polyorganosiloxane.

24. The article of claim 23, wherein each R¹² is a C₁₋₄ alkyl radical.

25. The article of claim 22, wherein the alkenyl-containing polyorganosiloxane comprises a vinyl-containing siloxane resin copolymer having the formula
(R¹⁴)₃SiO_{1/2} units (“M”) and SiO_{4/2} units (“Q”)
wherein each R¹⁴ is independently a vinyl radical or a monovalent hydrocarbon radical free of aliphatic unsaturation and containing no more than six carbon atoms, the ratio of (R¹⁴)₃SiO_{1/2} M units to SiO_{4/2} Q units being in the range of about 0.5:1 and about 1.5:1, and the resin having a vinyl content in a range between about 1.5 weight percent and about 3.5 weight percent of the vinyl containing siloxane resin copolymer.

26. The article of claim 22, wherein the hydride-containing polysiloxane has the formula
(R¹⁵)₃SiO—[(R¹⁵)(H)SiO]ᵥ—[(R¹⁵)₂SiO]_{w}—Si(R¹⁵)₃ (VII)
where R¹⁵ is independently hydrogen, a monovalent hydrocarbon radical, or a halogenated monovalent hydrocarbon radical having carbon atoms in the range between about 1 and about 10; v and w have values which are sufficient when added together to provide a viscosity of the hydride-containing polysiloxane in a range between about 10 centipoise and about 50,000 centipoise at 25 degrees Celsius.

27. The article of claim 26, wherein each R¹⁵ is independently a C₁₋₈ alkyl radical, phenyl, a C₃₋₁₀ fluoroalkyl radical, or hydrogen.

28. The article of claim 22, wherein the hydrosilation catalyst comprises platinum, ruthenium, rhodium, palladium, osmium, iridium, a complex thereof, or a mixture thereof.

29. The article of claim 22, wherein the inhibitor comprises an acetylenic alcohol, amine, di-alkenyl maleate, di-alkenyl fumarate, tetravinyltetramethylcyclotetrasiloxane, or a combination thereof.

30. The article of claim 20, further comprising a reinforcing or non-reinforcing filler.

31. The article of claim 20, further comprising an antioxidant.

32. The article of claim 31, wherein the antioxidant is present in an amount between about 0.01 weight percent and about 5 weight percent based on the total weight of the coating composition.

33. The article of claim 31, wherein the antioxidant comprises 2,2′-methylene-bis(4-methyl-6-tert-butylphenol).

34. The article of claim 20, wherein the weatherable surface is an aerodynamic surface.

35. The article of claim 20, wherein the article is an aircraft component.

36. The article of claim 20, wherein the article is a wind turbine component.

37. The article of claim 20, further comprising:
a second coating disposed between the weatherable surface and the weather resistant coating, wherein the second coating does not comprise hydrophilic functionality.
